(19) United States
(12) Patent Application Publication
(10) Pub. No.: US 2016/0368078 A1
(43) Pub. Date: Dec. 22, 2016

(54) METHOD OF WELDING WORKPIECES TOGETHER WHILE MINIMIZING DISTORTION

(71) Applicant: FORD GLOBAL TECHNOLOGIES, LLC, Dearborn, MI (US)

(72) Inventors: Daniel E. Wilkosz, Saline, MI (US); Gary Thomas Martini, Dexter, MI (US)

(21) Appl. No.: 14/742,744

(22) Filed: Jun. 18, 2015

(51) Int. Cl. B23K 11/11; B23K 26/60; H01M 8/04007; B23K 26/21

(52) U.S. Cl. CPC B23K 11/11; B23K 26/21; B23K 26/60; H01M 8/04007

(57) ABSTRACT

A method is provided for welding workpieces together while minimizing distortion in those workpieces. That method includes loading the workpieces to be welded together into a periphery clamp welding fixture. This is followed by tack welding the workpieces together by means of spot welds. Next is the removing of a portion of the welding fixture in order to provide an open field with respect to the workpieces and then completing welding of the workpieces together in the open field. Thus, the entire weld process may be completed utilizing a single periphery clamp welding fixture.

### TECHNICAL FIELD

This document relates generally to the welding field and, more particularly, to a method of welding workpieces together while minimizing distortion and required weld fixturing.

### BACKGROUND

The joining of thin metal fuel cell plate assemblies or other thin metal assemblies such as battery cell components or heat exchangers is traditionally done using continuous laser welding, resistance spot welding or ultrasonic welding. The first two of these welding processes of thin metal foils impart localized heat fluxes along and adjacent to the weld areas. Differential cooling of these heat fluxes introduces residual stress and subsequent distortion, wrinkling and twisting in the final weld assembly. To try and minimize part distortion, it is common to increase or decrease weld power, weld speed or a combination of the two and to break a continuous weld path into segmented sections in conjunction with custom design weld clamp fixturing. If a part requires multiple weld paths and they are in close proximity to each other, they themselves can impart additional distortion into the welded assembly and introduce complexity into weld clamp fixture designs. Segmenting the weld path generally requires the use of additional weld fixturing and process steps, subsequently increasing process complexity, cost, cycle time and chances of defects. Weld fixture tooling also restricts access of the laser beam and access of shielding gas used to minimize weld area oxidation and exhaust of fumes or weld spatter that may occur during welding. Thus, a need exists for a new and improved method for joining thin metal fuel cell plate assemblies and the like by means of welding.

### SUMMARY

In accordance with the purposes and benefits described herein, a new and improved method is provided for welding workpieces together while minimizing distortion. That method may be described as comprising the steps of loading the workpieces to be welded together into a welding fixture, tack welding those workpieces together, removing a portion of the welding fixture in order to provide an open field with respect to the workpieces and completing welding of the workpieces together in the open field. The method may further include maintaining alignment of the workpieces with a welder during and after removal of the portion of the welding fixture. Further, the method may include using fast cycle time pulsed/burst spot welds during tack welding in order to minimize heat flux experienced by the workpieces.

The method may further include fully joining workpieces using spot welds prior to completing welding. Those spot welds may range in size from between 0.01 mm and 0.04 mm in diameter for the tack welding. Further the welding may include completing the welding with a laser welder at a power of between 90 watts and 500 watts, a speed of between 100 mm/s and 1000 mm/s and the method may also include using spot weld pulse times of between 0.00025 sec and 0.003 sec.

In one possible embodiment, the welding is completed by continuous line welding in the open field. That continuous line welding may be performed with a separation of at least 5 mm between welds. In another possible embodiment, the method includes performing continuous line welding over spot welds used for the tack welding.

In yet another possible embodiment, the welding is completed by spot welding in the open field. Those spot welds may have a spacing density of between 0.5 mm and 15 mm and may have a size of between 25 μm and 150 μm in diameter.

In yet another possible embodiment, welding may be completed by overlapping spot welds in the open field. This includes overlapping the spot welds by between 25% and 35% of a diameter of the spot welds. In yet another possible embodiment, welding is completed by non- segmented fixture-free continuous line welding in the open field. In another embodiment, the welding may be completed without any further fixturing of the workpieces.

Still further, the method may include removing the portion of the fixture from a central area of the welding fixture and maintaining clamping pressure on the workpieces at the periphery thereof as that portion of the welding fixture is removed.

In accordance with yet another aspect, a method is provided of welding workpieces together while minimizing distortions in the workpieces comprising the step of tack welding the workpieces together followed by non-segmented fixture free continuous line welding.

In accordance with still another aspect, a method of welding thin metal fuel cell foils is provided. That method comprises loading thin metal fuel cell foils with a thickness of less than 0.5 mm into a welding fixture, tack welding the thin metal fuel cell foils together, removing a portion of the welding fixture in order to provide an open field with respect to the thin metal fuel cell foils and completing welding of the thin metal fuel cell foils together in the open field. Further, the method may include maintaining clamping pressure on the thin metal fuel cell foils as the portion of the welding fixture is removed and completing the welding by non-segmented fixture free continuous line welding in the open field.

In the following description, there are shown and described several preferred embodiments of the welding method. As it should be realized, the welding method is capable of other, different embodiments and its several details are capable of modification in various, obvious aspects all without departing from the welding method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the welding method and together with the description serve to explain certain principles thereof. In the drawing figures:

FIG. 1 is a top plan view illustrating the bottom plate of the base fixture frame and the workpieces/thin metal fuel cell foils to be loaded into/onto the welding fixture assembly.

FIG. 2 is a top plan view illustrating the clamping of the workpieces/thin metal fuel cell foils in place within the welding fixture assembly by means of periphery clamps.

FIG. 3 is a top plan view illustrating the positioning of a cover fixture frame over the workpieces/thin metal fuel cell foils, the periphery clamp fixture frame and the base fixture frame.

FIG. 4 is a perspective view illustrating the tack welding of the workpieces/thin metal fuel cell foils together by means of spot welds through apertures in the cover.

FIG. 5 is a top plan view illustrating the workpieces/thin metal fuel cell foils held together by tack welds following removal of the cover fixture frame. Note the open field provided for the completion of the welding process between the periphery clamps of the welding fixture.

FIG. 6 is a top plan view illustrating a continuous line weld adjacent prior existing spot welds utilized to tack weld the workpieces/thin metal fuel cell foils together.

FIG. 7 is a top plan view illustrating a series of aligned, separated spot welds.

FIG. 8 is a top plan view illustrating a series of aligned overlapping spot welds.

Reference will now be made in detail to the present preferred embodiments of the welding method, examples of which are illustrated in the accompanying drawing figures.

### DETAILED DESCRIPTION

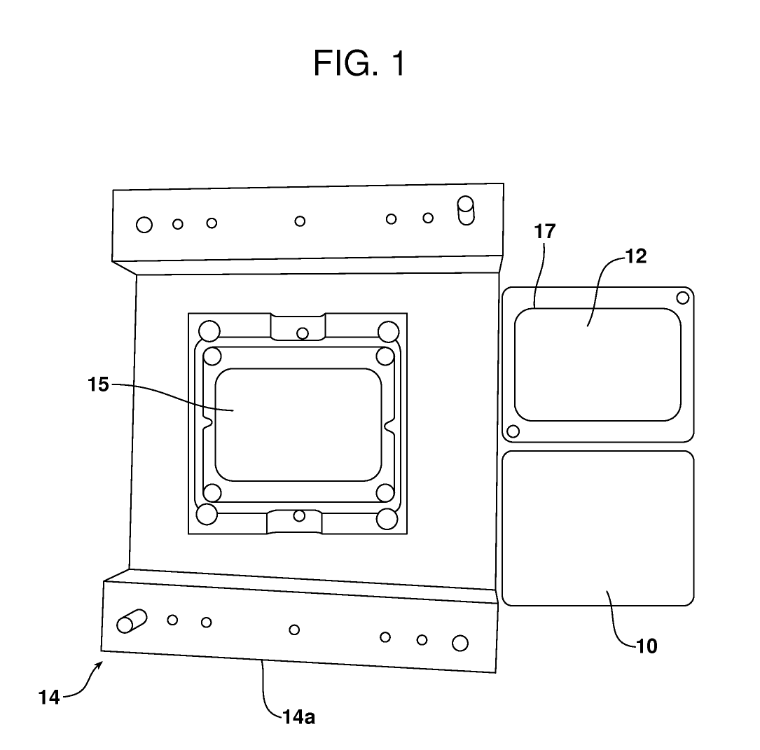

In the following description, reference will be made to the drawing FIGS. 1-8 which are presented for purposes of illustration and are representative of one possible embodiment of the welding method. As such, that method should not be considered as being limited to what is illustrated in those drawing figures. Further, for purposes of this document, the phrase “non-segmented fixture free continuous line welding” means there is no need to start and stop a design required continuous weld line to accommodate process flow interruptions such as for plate clamp fixture changes.

In the following description, the terms “workpiece” and “workpieces” include a thin metal fuel cell foil or thin metal fuel cell foils, but those terms should not be considered as limited thereto.

The method of welding workpieces together while minimizing distortion may be broadly described as including the step of loading the workpieces 10, 12 to be welded together into a welding fixture assembly 14. The welding fixture assembly 14 includes a base fixture frame 14a, a periphery clamp fixture frame 14b and a cover fixture frame 14c. After loading, the method includes tack welding the workpieces together by spot welds or other appropriate means, removing a portion of the welding fixture assembly 14 (in the illustrated embodiment, the cover fixture frame 14c) in order to provide an open field F with respect to the workpieces and completing welding of the workpieces together in the resulting open field F.

More specifically, FIG. 1 illustrates the workpieces 10, 12 that are loaded onto the base tooling 15 of the base frame 14a. In the illustrated embodiment, the flat workpiece 10 is loaded directly onto the base tooling 15 and the formed workpiece 12 with a flow channel 17 is then loaded on top of the flat workpiece 10.

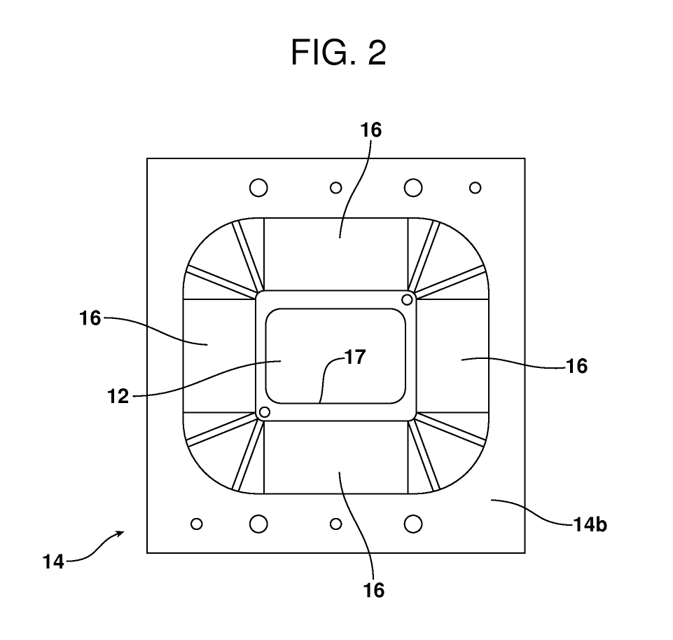

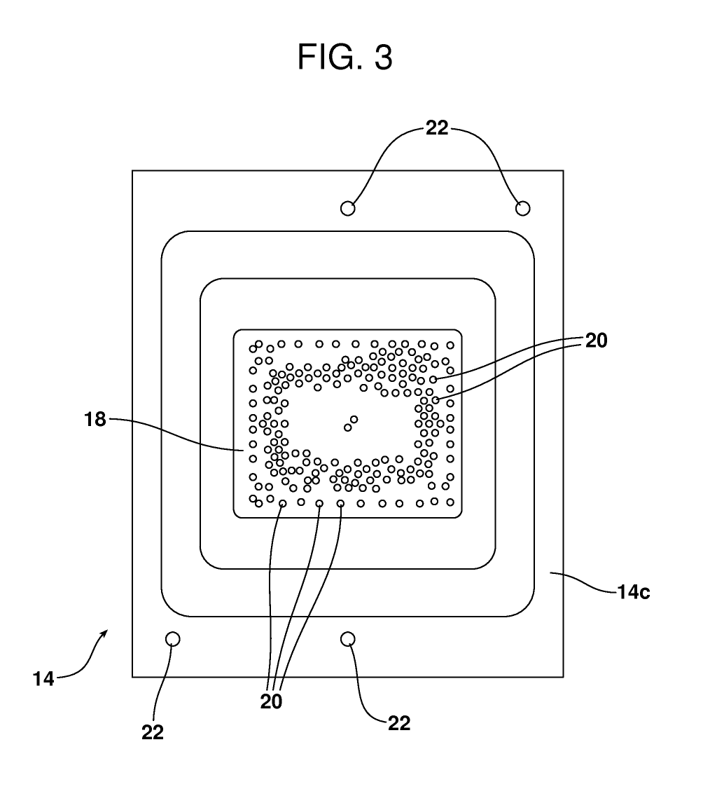

As illustrated in FIG. 2, the periphery clamps 16 of the periphery clamp fixture frame 14b interface against the periphery of the workpieces 10, 12 in order to clamp the workpieces together at the periphery thereof. Next, as illustrated in FIG. 3, the cover fixture frame 14c of the welding fixture assembly 14 is positioned to overlap the workpieces 10, 12. That cover fixture frame 14c includes a plurality of spaced apertures 20 through which tack welding is completed. The cover 18 may be held in place by fasteners 22.

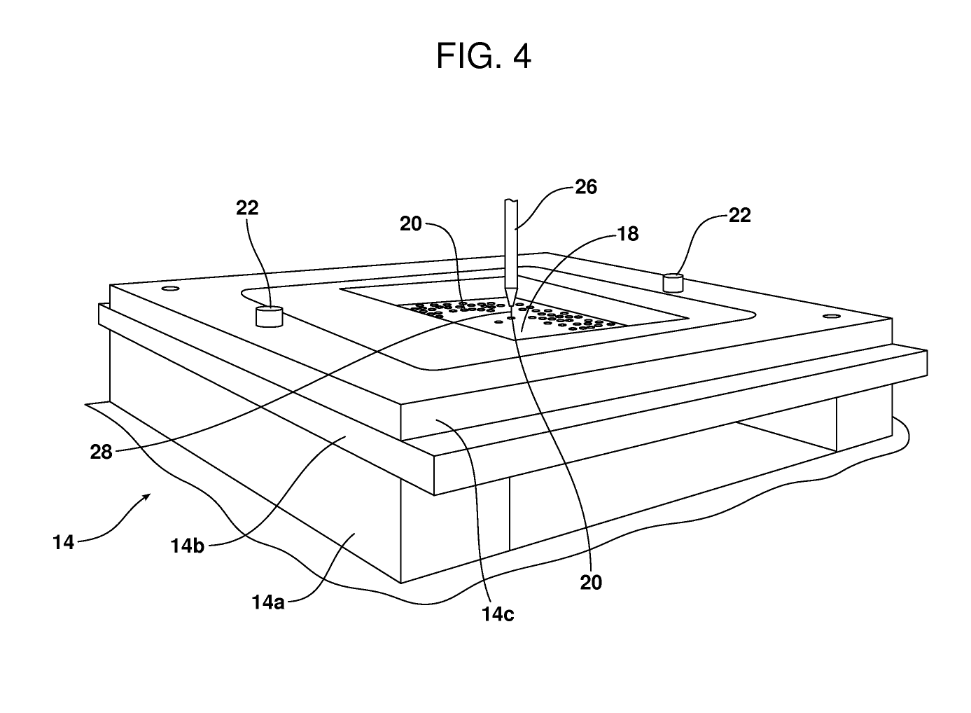

Reference is made to FIG. 4 schematically illustrating the laser head 26 of the laser welding apparatus focusing the laser beam 28 through an aperture 20 in the cover fixture frame 14c in order to complete a tack weld of the workpieces 10, 12 for holding the workpieces together. This process is repeated at any desired number of the apertures 20 in order to provide multiple tack welds for fully joining the workpieces 10, 12 together. This may be done using fast cycle time pulsed/burst spot welds which make it possible to minimize heat flux experienced by the workpieces 10, 12 during tack welding. Toward this end the laser welder may be operated at a power of between 90 watts and 500 watts, a speed of between 100 mm/s and 1000 mm/s and spot weld pulse times of between 0.00025 sec and 0.003 sec. The fact that the workpieces 10, 12 are fully joined prior to continuous line welding allows for improved weld parameters to be used thereby diminishing the distortion artifact imposed by any required continuous line welding.

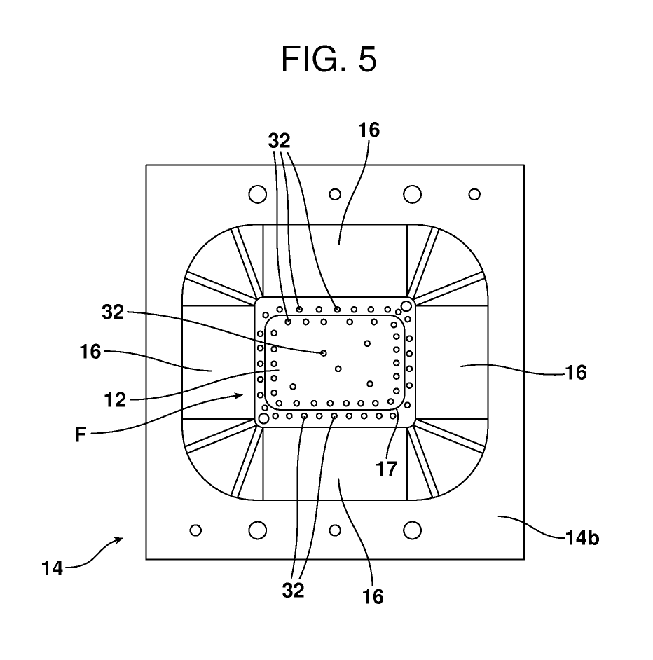

After the workpieces 10, 12 are fully joined by tack welding, the cover fixture frame 14c is removed while maintaining the alignment of the workpieces with the welding apparatus by maintaining clamping/holding pressure on the workpieces with the clamps 16 at the periphery of the workpieces. See FIG. 5. This is then followed by completing welding of the workpieces 10, 12 together in the open field F provided across the exposed face of the upper workpiece 12 between the periphery clamps 16.

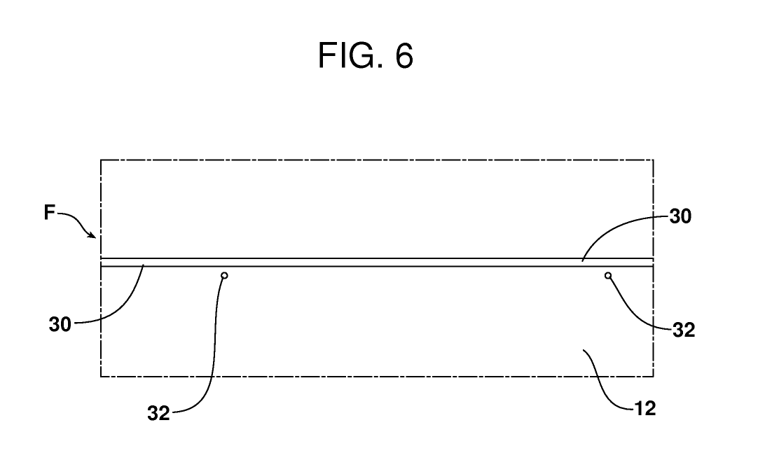

In one possible embodiment, welding is completed by continuous line welding in the open field F utilizing the laser welding apparatus. In one possible embodiment, this includes performing continuous line welding with a separation of at least 15 mm between continuous line welds. As illustrated in FIG. 6, the continuous line welds 30 may be provided adjacent to the tack welds 32. Alternatively, the continuous line welds may be provided over spot welds 32 used for tack welding.

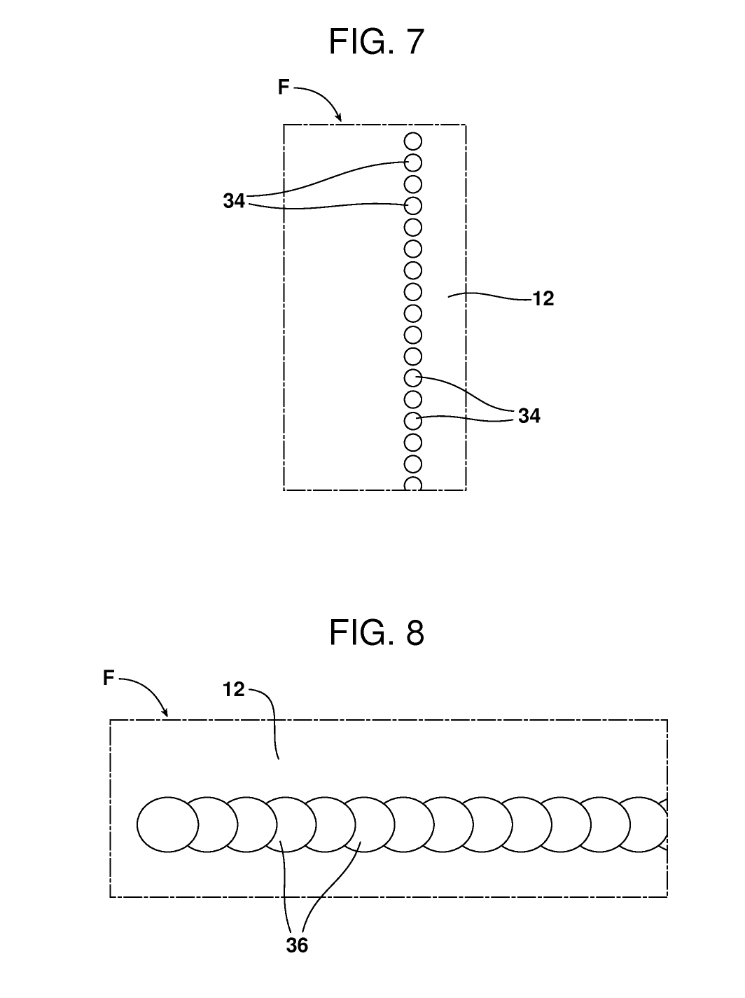

In another alternative embodiment, the welding of the workpieces 10, 12 may be completed by spot welding in the open field F. In one possible embodiment, those spot welds 34 have a density spacing of between 0.5 mm and 15 mm and a spot size of between 25 μm and 150 μm in diameter. Such separated spot welds 34 are further illustrated in FIG. 7. For many applications, high density spot welds 34 can replace traditional continuous line welding while still providing the desired strength and other weld attributes (other than hermetic sealing) all while reducing distortion artifacts in the workpieces 10, 12.

In yet another embodiment, the welding of the workpieces 10, 12 is completed by overlapping spot welds 36 in the open field F. Such overlapping spot welds 36 are illustrated in FIG. 8. In one possible embodiment the spot welds 36 are overlapped by between 10% and 35% of the diameter of the spot welds. In one embodiment, the spot welds 36 are overlapped by about 30%. Such overlapping spot welds 36 allow for hermetic sealing and may be used for many applications instead of a continuous line weld to reduce distortion artifacts in the workpieces 10, 12.

As should be appreciated, the welding method described in this document allows workpieces 10, 12 such as thin metal fuel cell foils with a thickness of less than 0.5 mm to be welded together in a single welding fixture assembly 14 by first tack welding the workpieces together and then completing welding by non-segmented fixture free continuous line welding in the open field F. Since the workpieces 10, 12 are held in a single welding fixture assembly 14 by periphery clamps 16 for both tack welding and any subsequent required welding operations including, for example, continuous line welding, the entire welding process is completed without further fixturing. This reduces the complexity of the welding operation, limits investment in weld fixture tooling and represents a significant advance in the art.

The foregoing has been presented for purposes of illustration and description. It is not intended to be exhaustive or to limit the embodiments to the precise form disclosed. Obvious modifications and variations are possible in light of the above teachings. For example, in order to ensure that the workpieces 10, 12 are maintained in proper, flat position against the base tooling 15, a vacuum may be applied beneath the workpieces to draw them fully down against the base tooling while being held at the periphery by the clamps 16. Further, while spot welds are identified for tack welding, it should be appreciated that short line welds could be used for the same purpose if desired. Such short line welds could be, for example, 0.10 mm wide by 1 mm long.

Still further, it should be appreciated that welded sample geometries will dictate the periphery clamp and spot weld clamp scenarios. Depending on geometry complexity, it stands to reason that more than one spot weld clamp configuration may be needed. All such modifications and variations are within the scope of the appended claims when interpreted in accordance with the breadth to which they are fairly, legally and equitably entitled.

What is claimed:

1. A method of welding workpieces together while minimizing distortion, comprising:
loading the workpieces to be welded together into a welding fixture;
tack welding said workpieces together;
removing a portion of said welding fixture in order to provide an open field with respect to said workpieces; and
completing welding of said workpieces together in said open field.

2. The method of claim 1, further including maintaining alignment of said workpieces with a welder during and after removal of said portion of said welding fixture.

3. The method of claim 1, further including using fast cycle time pulsed/burst spot welds during tack welding in order to minimize heat flux experienced by said workpieces.

4. The method of claim 1, including fully joining said workpieces using spot welds prior to completing welding.

5. The method of claim 1, including completing tack welding by using spot welds in a size range of between 0.01 mm and 0.04 mm in diameter for tack welding.

6. The method of claim 1, including completing said welding with a laser welder at a power of between 90 watts and 500 watts, a speed of between 100 mm/s and 1000 mm/s and spot weld pulse times of between 0.00025 sec and 0.003 sec.

7. The method of claim 1, wherein welding is completed by continuous line welding in said open field.

8. The method of claim 7, including performing continuous line welding with a separation of at least 15 mm between welds.

9. The method of claim 7, including performing continuous line welding over spot welds used for tack welding.

10. The method of claim 1 wherein welding is completed by spot welding in said open field.

11. The method of claim 10 wherein said spot welding includes weld spots having a spacing density of between 0.5 mm and 15 mm and a size of between 25 μm and 150 μm in diameter.

12. The method of claim 1 wherein welding is completed by overlapping spot welds in said open field.

13. The method of claim 12, further including overlapping said spot welds by between 10% and 35% of a diameter of said spot welds.

14. The method of claim 1 wherein welding is completed by non-segmented fixture free continuous line welding in said open field.

15. The method of claim 1, wherein welding is completed without any further fixturing of said workpieces.

16. The method of claim 1, including removing said portion from a central area of said welding fixture.

17. The method of claim 16, including maintaining clamping pressure on said workpieces at a periphery thereof as said portion of said welding fixture is removed.

18. A method of welding workpieces together while minimizing distortions in said workpieces, comprising:
tack welding said workpieces together followed by non-segmented fixture free continuous line welding.

19. A method of welding thin metal fuel cell foils together, comprising:
loading thin metal fuel cell foils with a thickness of less than 0.5 mm into a welding fixture;
tack welding said thin metal fuel cell foils together;
removing a portion of said welding fixture in order to provide an open field with respect to said thin metal fuel cell foils; and
completing welding of said thin metal fuel cell foils together in said open field.

20. The method of claim 19 including maintaining clamping pressure on said thin metal fuel cell foils as said portion of said welding fixture is removed and wherein welding is completed by non-segmented fixture free continuous line welding in said open field.
